(19) United States
(12) Patent Application Publication
(10) Pub. No.: US 2017/0017128 A1
(43) Pub. Date: Jan. 19, 2017

(54) LIQUID CRYSTAL DISPLAY HAVING IMPROVED PIXEL ELECTRODE SHAPES

(71) Applicant: SAMSUNG DISPLAY CO., LTD., Yongin-si (KR)

(72) Inventors: Sang Yong NO, Seoul (KR); Hyo Suk PARK, Seoul (KR); Kun-Wook HAN, Seongnam-si (KR)

(21) Appl. No.: 15/066,223

(22) Filed: Mar. 10, 2016

(30) Foreign Application Priority Data
Jul. 17, 2015 (KR) 10-2015-0101873

(51) Int. Cl. G02F 1/1343; G02F 1/1362

(52) U.S. Cl. CPC G02F 1/134336; G02F 1/13439; G02F 1/136286; G02F 2001/134345

(57) ABSTRACT

An exemplary embodiment of the present disclosure provides a liquid crystal display including: a first substrate; a pixel electrode disposed on the first substrate and including one or more unit pixel electrodes; a common electrode facing the pixel electrode; and a liquid crystal layer disposed between the pixel electrode and the common electrode, wherein a length of a short side of the one unit pixel electrode may be equal to or less than about 100 μm, a length of a long side of the one unit pixel electrode may be equal to or greater than about two times the length of the short side, and the one unit pixel electrode may include a stem portion including a horizontal stem and a vertical stem crossing each other and a plurality of minute branch electrodes extending from the stem portion.

### CROSS-REFERENCE TO RELATED APPLICATION

This application claims priority to, and the benefit of, Korean Patent Application No. 10-2015-0101873 filed in the Korean Intellectual Property Office on Jul. 17, 2015, the entire contents of which are incorporated herein by reference.

### BACKGROUND

(a) Field

Embodiments of the present disclosure relate generally to liquid crystal displays. More specifically, embodiments of the present disclosure relate to liquid crystal displays having improved pixel electrode shapes.

(b) Description of the Related Art

Liquid crystal displays (LCDs) are one of the most widely used flat panel displays. An LCD includes a pair of panels provided with field-generating electrodes, such as pixel electrodes and a common electrode, with a liquid crystal (LC) layer interposed between the two panels. The LCD displays images by applying voltages to the field-generating electrodes to generate an electric field in the LC layer. The field determines the orientations of LC molecules therein, to adjust polarization of incident light thereto.

Among LCDs, a vertically aligned mode LCD, in which liquid crystal molecules are aligned so that their long axes are perpendicular to the upper and lower panels when no electric field is applied, has seen recent attention because its contrast ratio is high and a wide reference viewing angle is somewhat easily implemented.

In order to implement a wide viewing angle in such a vertically aligned mode

(VA) LCD, a plurality of domains having different alignment directions for the liquid crystal molecules may be formed within one pixel.

As such, a method of forming cutouts such as minute slits in the field generating electrode, or forming protrusions on the field generating electrode, is used as a means for forming the domains. According to this method, the plurality of domains may be formed so as to align the liquid crystal molecules in a direction perpendicular to the fringe fields generated by edges of the cutouts or the protrusions and a fringe field formed between the field generating electrodes facing the edges. However, in a curved liquid crystal display, the cutouts, the protrusions, and the like may generate spots due to misalignment between the upper and lower panels thereof.

The above information disclosed in this Background section is only to enhance the understanding of the background of the disclosure and therefore it may contain information that does not form the prior art that is already known in this country to a person of ordinary skill in the art.

### SUMMARY

Embodiments of the present disclosure provide a liquid crystal display that can prevent image texture from occurring due to bending, and can improve transmittance and response speed, by modifying a shape of a pixel electrode.

An exemplary embodiment of the present disclosure provides a liquid crystal display including: a first substrate; a pixel electrode disposed on the first substrate and including one or more unit pixel electrodes; a common electrode facing the pixel electrode; and a liquid crystal layer disposed between the pixel electrode and the common electrode, wherein a length of a short side of the one unit pixel electrode may be equal to or less than about 100 μm, a length of a long side of the one unit pixel electrode may be equal to or greater than about two times the length of the short side, and the one unit pixel electrode may include a stem portion including a horizontal stem and a vertical stem crossing each other and a plurality of minute branch electrodes extending from the stem portion.

The one unit pixel electrode may have a rectangular shape.

The pixel electrode may include six unit pixel electrodes, and the six unit pixel electrodes may be disposed sequentially along a line so that the long sides of adjacent unit pixel electrodes face each other.

The liquid crystal layer may include a plurality of liquid crystal molecules, and the liquid crystal molecules may be aligned so that the major axes thereof are substantially perpendicular to a surface of the first substrate when an electric field is not applied to the liquid crystal layer.

The liquid crystal display may further include a gate line extending in a first direction and a data line extending in a second direction, wherein the liquid crystal display may be curved along a direction parallel to at least one of the first direction and the second direction.

The common electrode may be substantially planar.

The pixel electrode may include a first subpixel electrode and a second subpixel electrode, the first subpixel electrode and the second subpixel electrode may each include two unit pixel electrodes, and the two unit pixel electrodes may be formed sequentially along a line so that short sides of the two unit pixel electrodes face each other.

The liquid crystal layer may include a plurality of liquid crystal molecules, and the liquid crystal molecules may be aligned so that major axes thereof are substantially perpendicular to a surface of the first substrate when an electric field is not applied to the liquid crystal layer.

The liquid crystal display may further include a gate line extending in a first direction and a data line extending in a second direction, wherein the liquid crystal display may be curved along a direction parallel to at least one of the first direction and the second direction.

The pixel electrode may include a first subpixel electrode and a second subpixel electrode, the first subpixel electrode may include three unit pixel electrodes that are formed sequentially along a line so that long sides of adjacent unit pixel electrodes face each other, and the second subpixel electrode may include four unit pixel electrodes.

The liquid crystal layer may include a plurality of liquid crystal molecules, and the liquid crystal molecules may be aligned so that the major axes thereof are substantially perpendicular to a surface of the first substrate when an electric field is not applied to the liquid crystal layer.

The liquid crystal display may further include a gate line extending in a first direction and a data line extending in a second direction, wherein the liquid crystal display is curved along a direction parallel to at least one of the first direction and the second direction.

The pixel electrode may include a first subpixel electrode and a second subpixel electrode, the first subpixel electrode may include two unit pixel electrodes that are formed sequentially along a line so that long sides of the two unit pixel electrodes face each other, and the second subpixel electrode may include four unit pixel electrodes.

At least one of the unit pixel electrodes may have a trapezoidal shape.

The liquid crystal layer may include a plurality of liquid crystal molecules, and the liquid crystal molecules may be aligned so that long axes thereof are substantially perpendicular to a surface of the first substrate when an electric field is not applied to the liquid crystal layer.

The liquid crystal display may further include a gate line extending in a first direction and a data line extending in a second direction, wherein the liquid crystal display may be curved along a direction parallel to at least one of the first direction and the second direction.

The pixel electrode may include a first subpixel electrode and a second subpixel electrode, the first subpixel electrode and the second subpixel electrode each may include two unit pixel electrodes, and at least one of the unit pixel electrodes may have a parallelogram shape.

The two unit pixel electrodes of the first subpixel electrode or the second subpixel electrode may have different shapes.

The liquid crystal layer may include a plurality of liquid crystal molecules, and the liquid crystal molecules may be aligned so that long axes thereof are substantially perpendicular to a surface of the first substrate when an electric field is not applied to the liquid crystal layer.

The liquid crystal display may further include a gate line extending in a first direction and a data line extending in a second direction, wherein the liquid crystal display may be curved along a direction parallel to at least one of the first direction and the second direction.

According to an embodiment of the present disclosure, it is possible to prevent image texture from occurring due to bending, and to improve transmittance and response speed by modifying a shape of a pixel electrode.

### BRIEF DESCRIPTION OF THE DRAWINGS

FIG. 1 illustrates a detailed top plan view of a pixel according to an exemplary embodiment of the present disclosure.

FIG. 2 illustrates a cross-sectional view taken along line II-II of FIG. 1.

FIG. 3 is a schematic diagram representing liquid crystal control as arrows in a unit pixel electrode, a length of a short side of which is equal to or less than about 100 μm and a length of a long side of which is equal to or less than two times the short side.

FIG. 4 illustrates experimental data comparing transmittance of a comparative example of a 12-division liquid crystal display having a square-shaped unit pixel electrode to transmittances of exemplary embodiments of 6-division and 4-division liquid crystal displays respectively having rectangular-shaped unit pixel electrodes.

FIG. 5 illustrates experimental data comparing the response time of a comparative example of a 12-division liquid crystal display having a square-shaped unit pixel electrode to the response time of an exemplary embodiment of a 4-division liquid crystal display having a rectangular-shaped unit pixel electrode.

FIG. 6 illustrates experimental data of a control time according to a size of a unit pixel electrode in a comparative example of a 12-division liquid crystal display.

FIG. 7 illustrates a detailed top plan view of a pixel according to an exemplary embodiment of the present disclosure.

FIGS. 8 to 12 illustrate schematic diagrams of a pixel electrode of a liquid crystal display according to an exemplary embodiment of the present disclosure.

FIG. 13 illustrates a perspective view of a liquid crystal display according to an exemplary embodiment of the present disclosure.

### DETAILED DESCRIPTION OF THE EMBODIMENTS

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

In the drawings, the thickness of layers, films, panels, regions, etc., are exaggerated for clarity. The various Figures are thus not to scale. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

All numerical values are approximate, and may vary. All examples of specific materials and compositions are to be taken as nonlimiting and exemplary only. Other suitable materials and compositions may be used instead.

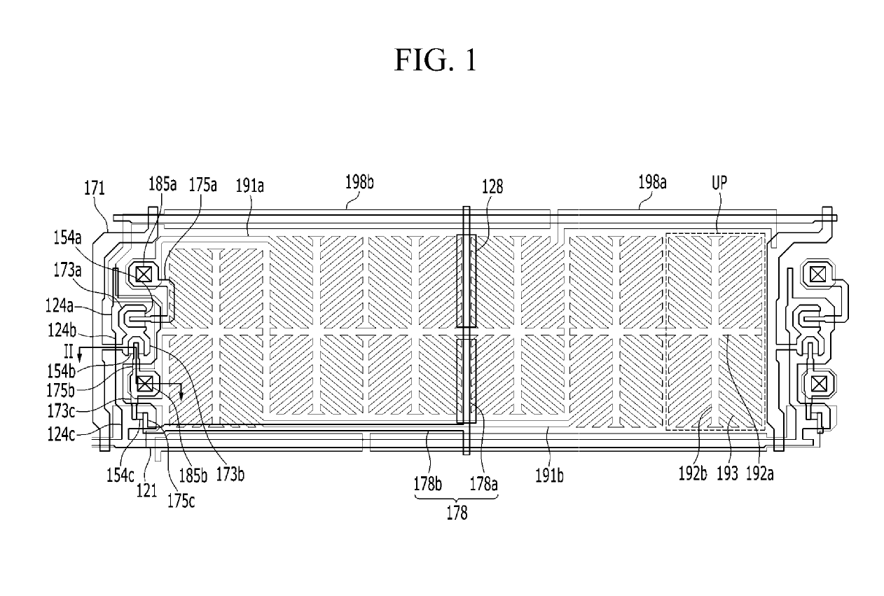

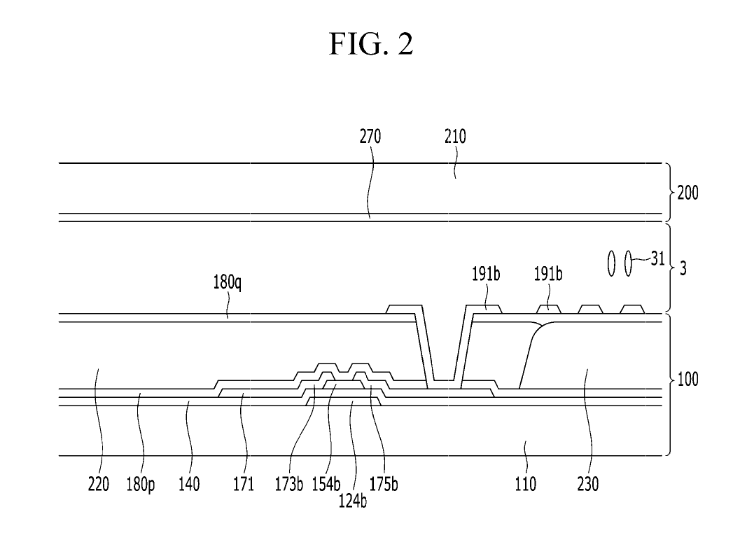

A liquid crystal display according to an exemplary embodiment of the present disclosure will now be described in detail with reference to FIGS. 1 and 2.

FIG. 1 illustrates a detailed top plan view of a pixel according to an exemplary embodiment of the present disclosure, and FIG. 2 illustrates a cross-sectional view taken along line II-II of FIG. 1.

First, a lower panel 100 will be described. Here, a plurality of gate lines 121 are disposed on a first substrate 110 that is made of transparent glass, plastic, or the like. The gate line 121 substantially extends in a horizontal direction, and includes a first gate electrode 124a, a second gate electrode 124b, and a third gate electrode 124c that protrude and extend upward from the gate line 121. The first gate electrode 124a, the second gate electrode 124b, and the third gate electrode 124c extend upward from the gate line 121, and the second gate electrode 124b and the first gate electrode 124a extend from the third gate electrode 124c. The first gate electrode 124a and the second gate electrode 124b may be formed as regions of one continuous expanded region or protrusion.

A gate insulating layer 140 is disposed on the gate line 121, and a first semiconductor 154a, a second semiconductor 154b, and a third semiconductor 154c are respectively disposed at positions of the gate insulating layer 140 corresponding to the first gate electrode 124a, the second gate electrode 124b, and the third gate electrode 124c.

A data conductor, which includes a data line 171, a first drain electrode 175a, a second drain electrode 175b, a third source electrode 173c, a third drain electrode 175c, and a reference voltage line 178, is disposed on the first semiconductor 154a, the second semiconductor 154b, the third semiconductor 154c, and the gate insulating layer 140.

The data line 171 substantially extends in a vertical direction, and includes a first source electrode 173a and a second source electrode 173b, each extending toward the first and second gate electrodes 124a and 124b.

The reference voltage line 178 may include a main line 178a substantially parallel to the data line 171 and a branch portion 178b that extends from the main line 178a and is substantially parallel to the gate line 121. The branch portion 178b extends along the outside of a display area to an area where a thin film transistor is positioned, and one end of the branch portion 178b forms the third drain electrode 175c. An electrode 128 that prevents light leakage around the main line 178a and is made of the same material as the gate line 121 may be formed below the main line 178a.

The first drain electrode 175a faces the first source electrode 173a, the second drain electrode 175b faces the second source electrode 173b, and the third drain electrode 175c faces the third source electrode 173c. The third source electrode 173c is connected to the second drain electrode 175b.

The first gate electrode 124a, the first source electrode 173a, and the first drain electrode 175a form a first thin film transistor together with the first semiconductor 154a;

the second gate electrode 124b, the second source electrode 173b, and the second drain electrode 175b form a second thin film transistor together with the second semiconductor 154b; and the third gate electrode 124c, the third source electrode 173c, and the third drain electrode 175c form a third thin film transistor together with the third semiconductor 154c. In this configuration, although a data voltage is applied to the first thin film transistor and the second thin film transistor through the source electrode thereof, a reference voltage is applied to the third thin film transistor through the source electrode thereof.

A lower passivation layer 180p, which may be made of an inorganic insulation material such as a silicon nitride or a silicon oxide, is disposed on the data conductor, and a color filter 230 and a light blocking member 220 are disposed on the lower passivation layer 180p. Alternatively, at least one of the color filter 230 and the light blocking member 220 may be displayed on an upper panel 200.

Each color filter 230 may express one of three primary colors, such as red, green, and blue, and the color filters 230 may overlap each other on the data line 171.

The light blocking member 220 is also referred to as a black matrix, and blocks light leakage. The light blocking member 220 extends horizontally along the gate line 121, covers an area in which the first thin film transistor, the second thin film transistor, and the third thin film transistor are disposed, extends along the data line 171, and covers a periphery of the data line 171. An area that is not covered by the light blocking member 220 emits light so as to display an image.

An upper passivation layer 180q is disposed on the color filter 230 and the light blocking member 220. The upper passivation layer 180q prevents the color filter 230 from being lifted, and suppresses contamination of the liquid crystal layer 3 by an organic material such as a solvent flowing from the color filter 230, so as to prevent defects such as afterimages that may occur when a screen is driven. The upper passivation layer 180q may be made of an inorganic insulation material such as a silicon nitride or a silicon oxide, or may be made of an organic material. The upper passivation layer 180q may be omitted, as desired.

A plurality of contact holes 185a and 185b that respectively expose the first drain electrode 175a and the second drain electrode 175b are formed in the lower passivation layer 180p and the upper passivation layer 180q.

The plurality of pixel electrodes 191 are formed on the upper passivation layer 180q. The pixel electrode 191 one of each pixel includes one first subpixel electrode 191a and one second subpixel electrode 191b.

The first subpixel electrode 191a and the second subpixel electrode 191b are disposed along a horizontal direction (i.e., their major axes extend substantially horizontally in the view of FIG. 1). The first drain electrode 175a of the first thin film transistor is connected to the first subpixel electrode 191a through a first contact hole 185a. The second drain electrode 175b of the second thin film transistor is connected to the second subpixel electrode 191b through a second contact hole 185b.

The third thin film transistor connects the second drain electrode 175b to the reference voltage line 178 of the second thin film transistor, to change a level of a data voltage applied to the second subpixel electrode 191b. Accordingly, an electric field strength between the first subpixel electrode 191a and a common electrode 270 described later, and an electric field strength between the second subpixel electrode 191b and the common electrode 270, may be different. In this embodiment, the electric field strength between the first subpixel electrode 191a and the common electrode 270 is the greater of the two.

The first subpixel electrode 191a and the second subpixel electrode 191b each include a plurality of unit pixel electrodes UP. Each of the unit pixel electrodes UP includes a pair of horizontal and vertical stems 192a and 192b, and a plurality of minute branch electrodes 193 obliquely extending from the horizontal and vertical stems 192a and 192b. A position at which the horizontal stem 192a and the vertical stem 192b cross may be substantially a center of the unit pixel electrode UP.

The horizontal stem 192a and the vertical stem 192b are oriented substantially perpendicular to each other, and the minute branch electrodes 193 extend from the horizontal stem 192a and the vertical stem 192b. The minute branch electrodes 193 disposed at upper left sides of the horizontal stem 192a and the vertical stem 192b obliquely extend in an upper left direction, and minute branch electrodes 193 disposed at upper right sides thereof obliquely extend in an upper right direction. Similarly, the minute branch electrodes 193 disposed at lower left sides of the horizontal stem 192a and the vertical stem 192b obliquely extend in a lower left direction, and minute branch electrodes 193 disposed at lower right sides thereof obliquely extend in a lower right direction.

For unit pixel electrodes UP that are not square, a length of each of their short sides is equal to or less than about 100 μm, and a length of each of their long sides is equal to or greater than two times the short side. The shorter the length of the short side, the better, so that its length is equal to or less than about 100 μm. In the exemplary embodiment of FIG. 1, each unit pixel electrode UP has a rectangular shape, and the first subpixel electrode 191a and the second subpixel electrode 191b respectively include three unit pixel electrodes UP. The unit pixel electrodes UP of the first subpixel electrode 191a and the second subpixel electrode 191b have substantially the same size and shape. The unit pixel electrodes UP of the first and second subpixel electrodes 191a and 191b are arranged sequentially along a line, with their long sides facing each other.

Alternatively, while keeping the lengths of the short sides of the unit pixel electrode UP each equal to or less than about 100 μm and lengths of the long sides each equal to or greater than two times the lengths of the short sides, the unit pixel electrode UP may have any other shape besides a rectangular shape, the number of unit pixel electrodes UP of the first subpixel electrode 191a and the second subpixel electrode 191b may vary, and the sizes and shapes thereof may also vary.

Light leakage-blocking electrodes 198a and 198b, which extend over the gate line 121, may be formed on some unit pixel electrodes UP of the first subpixel electrode 191a or the second subpixel electrode 191b, and they may serve to block light leakage along with the light blocking member 220.

A lower alignment layer (not shown) is formed on the pixel electrode 191, and it may be a vertical alignment layer. However, when the alignment layer is formed, an additional process by which the liquid crystal molecules 31 are imparted a pretilt, which will be described later, may be omitted if desired.

The upper panel 200 will now be described.

A common electrode 270, that is made of a transparent conductive material and to which a common voltage is applied, is formed on a second substrate 210 that is made of glass, plastic, and/or the like. The common electrode 270 is formed as a plate-shaped or flat, planar electrode.

An upper alignment layer (not shown) is formed on the common electrode 270, and it may be a vertical alignment layer. However, a process of forming a pretilt for the upper alignment layer through an electric field ultra-violet (UV) process may be omitted if desired.

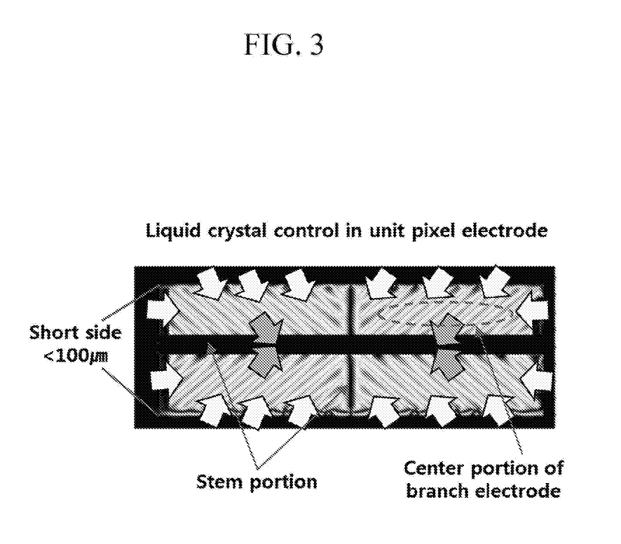

The liquid crystal layer 3 disposed between the two display panels 100 and 200 may have a negative dielectric anisotropy, the liquid crystal molecules 31 of the liquid crystal layer 3 may be aligned so that long axes thereof may be substantially perpendicular to surfaces of the two display panels 100 and 200 in a state in which an electric field is not present, and the pretilt directions of the liquid crystal molecules 31 in one pixel area may all be the same. For example, when an electric field is not applied, the direction of the long axes of the liquid crystal molecules 31 with respect to the surfaces of the two display panels 100 and 200 may form an included angle of about 89.5° to 90°. Even though the long axes of the liquid crystal molecules 31 are perpendicular to the surfaces of the two display panels 100 and 200 when the electric field is not applied, when the short side of the unit pixel electrode UP is sufficiently short, even the liquid crystals of a center portion of a branch electrode may be efficiently controlled through an edge-side control generator, and a stem-side control generator and response speed may be improved. This will be described later with reference to FIG. 3.

The first subpixel electrode 191a and the second subpixel electrode 191b (to which the data voltage and the reference voltage each are applied) generate an electric field together with the common electrode 270 of the upper panel 200, thereby determining the direction of the liquid crystal molecules 31 of the liquid crystal layer 3 between the electrodes 191 and 270. As such, luminance of light passing through the liquid crystal layer 3 is changed depending on the determined direction of the liquid crystal molecules 31.

Effects that such a unit pixel electrode UP provide will be described in detail with reference to FIGS. 3 to 5.

FIG. 3 is a schematic diagram representing liquid crystal control as arrows in a unit pixel electrode, a length of a short side of which is equal to or less than about 100 flat and a length of a long side of which is equal to or less than two times the short side. In the unit pixel electrode, liquid crystal control is mainly generated at the edge and the stem of the unit pixel electrode. In FIG. 3, a white arrow stands for a direction of the edge-side liquid crystal control, and a darker arrow stands for a direction of the stem-side liquid crystal control. When a length of the short side of the unit pixel electrode is equal to or less than about 100 μm, since a distance between the edge-side control generator and the stem-side control generator is sufficiently small, the liquid crystals of the center portion of the branch electrode may be efficiently controlled through the edge-side control generator and the stem-side control generator. Accordingly, response speed may be improved.

In addition, when the length of the short side is equal to or less than about 100 μm, even if the length of the long side is extended, the response speed is not substantially affected. Thus, the length of the long side may be formed to be equal to or greater than two times the length of the short side. Accordingly, an area of one unit pixel electrode may be maximized and the pixel electrode is divided into a number of electrodes corresponding to the unit pixel electrodes, thereby reducing the boundary areas between the divided pixel electrodes. If the ratio between the areas of the pixel electrodes and the boundary areas is reduced, transmittance of the liquid crystal display increases.

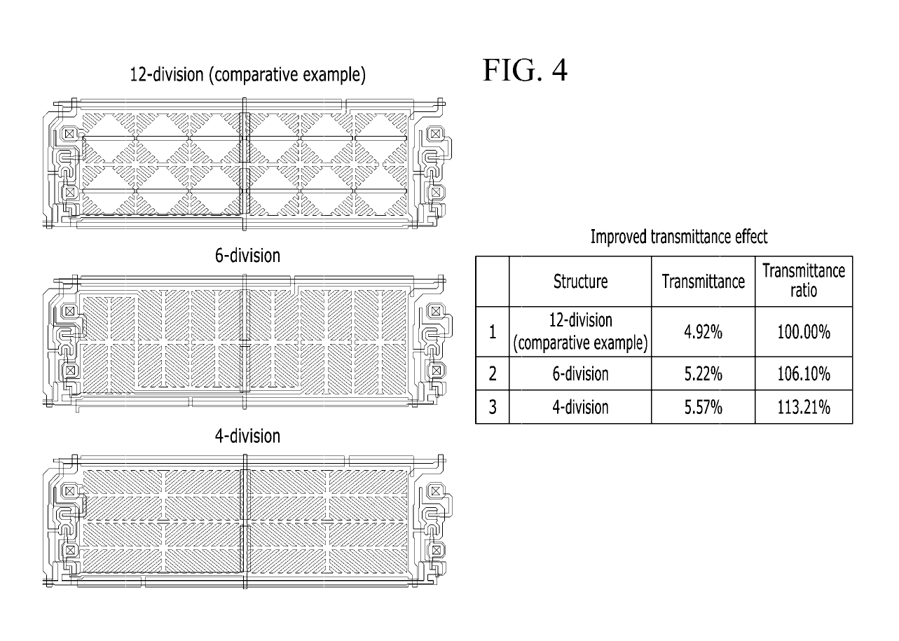

FIG. 4 illustrates experimental data comparing transmittance of a comparative example of a 12-division liquid crystal display having square-shaped unit pixel electrodes, to transmittances of exemplary embodiments of 6-division and 4-division liquid crystal displays respectively having rectangular-shaped unit pixel electrodes. The transmittance of the 12-division comparative example has been found to be about 4.92%, the transmittance of the 6-division exemplary embodiment was found to be about 5.22%, and the transmittance of the 4-division exemplary embodiment was found to be about 5.57%. In other words, when the transmittance of the 12-division comparative example is assumed to be about 100%, the transmittance of the 6-division exemplary embodiment is improved by about 6.10%, and the transmittance of the 4-division exemplary embodiment is improved by about 13.21%.

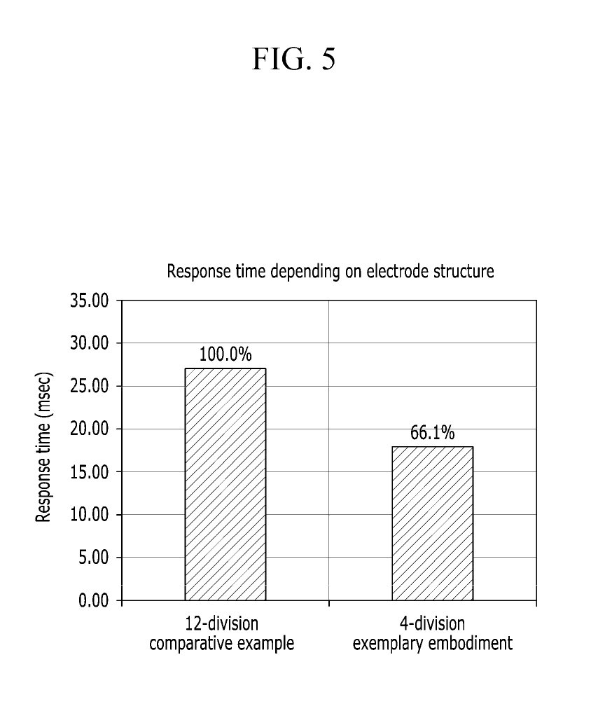

FIG. 5 illustrates experimental data comparing response time of a comparative example of a 12-division liquid crystal display having square-shaped unit pixel electrodes to response time of an exemplary embodiment of a 4-division liquid crystal display having rectangular-shaped unit pixel electrodes. When the response time of the 12-division comparative example is about 100%, it can be seen that the response time of the 4-division exemplary embodiment was found to be about 66.1%, that is, the response time is shortened by about 34%.

Accordingly, a unit pixel electrode, the length of the short side of which is equal to or less than about 100 μm and the length of the long side of which is equal to or less than two times the short side, may substantially improve response speed and transmittance as compared to square-shaped unit pixel electrodes of, for instance, a 12-division comparative example.

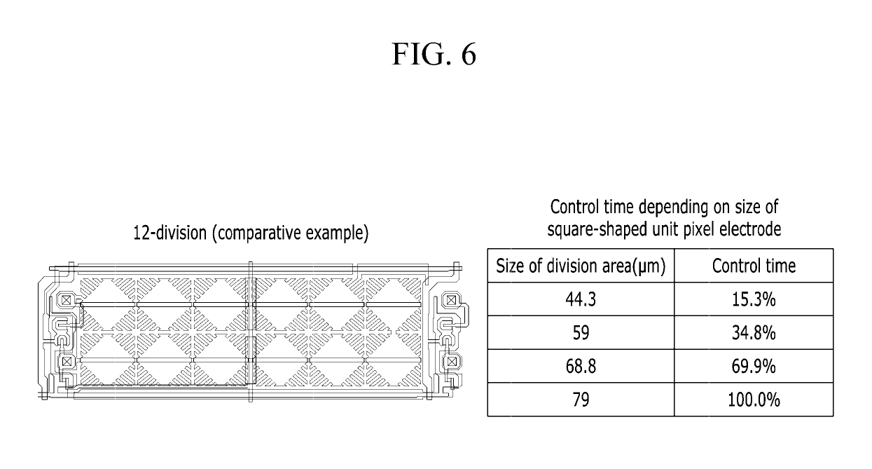

FIG. 6 illustrates experimental data of control time according to a size of a unit pixel electrode in a comparative example of a 12-division liquid crystal display. Referring to FIG. 6, it can be seen that as the size of the divided area (i.e. the area of each unit pixel electrode) increases to improve transmittance, the control time gradually increases and the response speed decreases.

In addition, even though slits, protrusions, and the like are omitted from the common electrode and the process of forming a pretilt is omitted while the alignment layer is formed, since the liquid crystal display according to the exemplary embodiment of the present disclosure may sufficiently ensure controllability, when the present exemplary embodiment is applied to a curved liquid crystal display, it is possible to prevent texture from occurring due to misalignment between the upper and lower panels and to reduce costs by reducing the difficulty of manufacturing processes.

Further, it is possible to additionally improve overall liquid crystal control by increasing the widths of the horizontal and vertical stems, or by forming a step or an inclined portion with an organic layer therebelow.

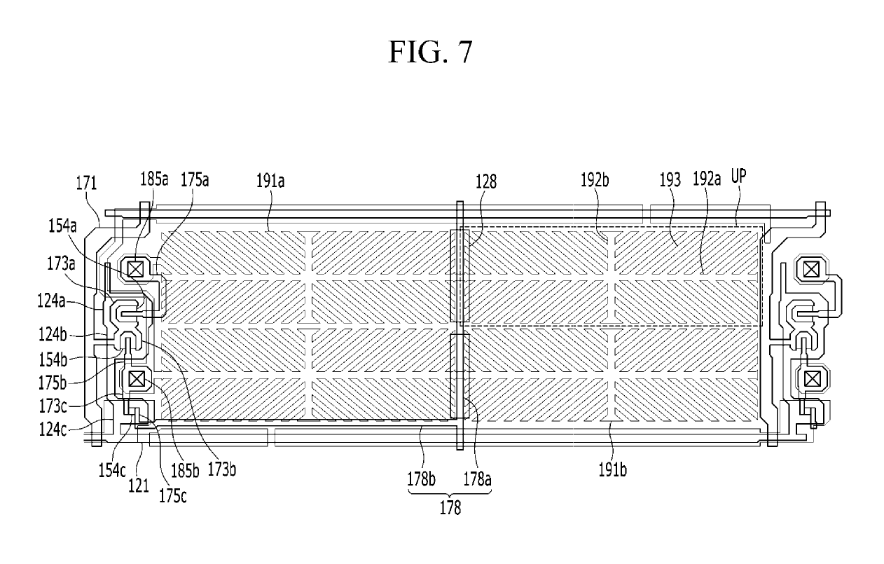

A liquid crystal display according to another exemplary embodiment of the present disclosure will now be described with reference to FIG. 7. FIG. 7 illustrates a detailed top plan view of a pixel according to an exemplary embodiment of the present disclosure. Referring to FIG. 7, the liquid crystal display according to the present exemplary embodiment is similar to the liquid crystal display according to the exemplary embodiment described with reference to FIGS. 1 and 2. Accordingly, detailed descriptions of the same constituent elements will be omitted.

The pixel electrode 191 of one pixel includes the first subpixel electrode 191a and the second subpixel electrode 191b. The first subpixel electrode 191a and the second subpixel electrode 191b are disposed along a horizontal direction.

The first subpixel electrode 191a and the second subpixel electrode 191b each include a plurality of unit pixel electrodes UP. Each of the unit pixel electrodes UP includes a pair of horizontal and vertical stems 192a and 192b respectively, and a plurality of minute branch electrodes 193 obliquely extending from the pair of horizontal and vertical stems 192a and 192b. A position at which the horizontal stem 192a and the vertical stem 192b cross may be substantially a center of the unit pixel electrode UP.

The horizontal stem 192a and the vertical stem 192b are oriented perpendicular to each other, and the minute branch electrodes 193 extend from the horizontal stem 192a and the vertical stem 192b. The minute branch electrodes 193 disposed at upper left sides of the horizontal stem 192a and the vertical stem 192b obliquely extend in an upper left direction, and minute branch electrodes 193 disposed at upper right sides thereof obliquely extend in an upper right direction. Similarly, the minute branch electrodes 193 disposed at lower left sides of the horizontal stem 192a and the vertical stem 192b obliquely extend in a lower left direction, and minute branch electrodes 193 disposed at lower right sides thereof obliquely extend in a lower right direction.

In the unit pixel electrodes UP, a length of each of the short sides is equal to or less than about 100 μm, and a length of each of the long sides is equal to or greater than two times the short side. Within limits, the shorter the length of the short side, the more advantages are demonstrated, and in particular it is preferable to maintain a short-side length that is equal to or less than about 100 μm. In the exemplary embodiment of FIG. 7, the unit pixel electrode UP has a rectangular shape, and the first subpixel electrode 191a and the second subpixel electrode 191b respectively include two unit pixel electrodes UP. The unit pixel electrodes UP of the first subpixel electrode 191a and the second subpixel electrode 191b have the same size and shape. The two unit pixel electrodes UP included in the first subpixel electrode 191a are arranged side by side with long sides facing each other, and the two unit pixel electrodes UP included in the second subpixel electrode 191b are also arranged side by side with their long sides facing each other.

Alternatively, so long as lengths of the short sides of the unit pixel electrode UP are each equal to or less than about 100 μm and lengths of the long sides are each equal to or greater than two times the lengths of the short sides, the unit pixel electrode UP may have any other shape besides a rectangular shape, the numbers of unit pixel electrodes UP of the first subpixel electrode 191a and the second subpixel electrode 191b may vary, and the sizes and shapes thereof may also vary.

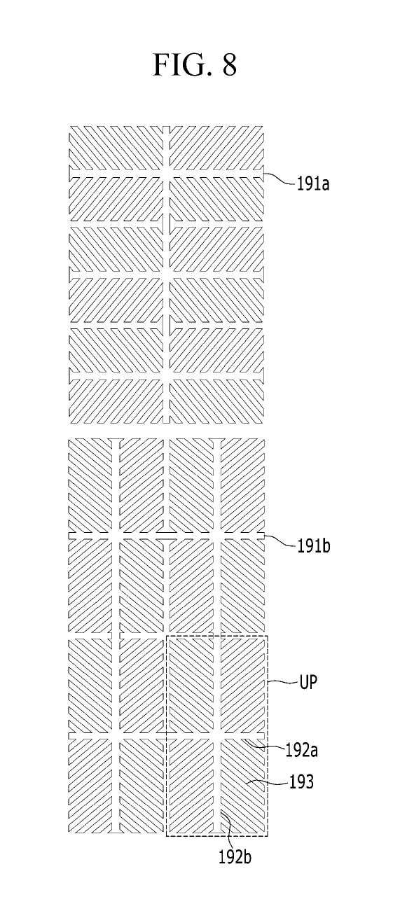

A pixel electrode 191 for a liquid crystal display according to the present exemplary embodiment will now be described with reference to FIGS. 8 to 12. FIGS. 8 to 12 illustrate schematic diagrams of a pixel electrode of a liquid crystal display according to an exemplary embodiment of the present disclosure. Detailed description of the same constituent elements as those of the pixel electrode 191 of the liquid crystal display according to the exemplary embodiment described with reference to FIGS. 1 and 2 are omitted.

Referring to FIG. 8, the first subpixel electrode 191a and the second subpixel electrode 191b each include a plurality of unit pixel electrodes UP. Each of the unit pixel electrodes UP includes a pair of horizontal and vertical stems 192a and 192b, and a plurality of minute branch electrodes 193 obliquely extending from the pair of horizontal and vertical stems 192a and 192b. The length of each of the short sides of each unit pixel electrode UP is equal to or less than about 100 μm, and the length of each of the long sides is equal to or greater than two times the short side. In the exemplary embodiment of FIG. 8, each unit pixel electrode UP has a rectangular shape, and the first subpixel electrode 191a and the second subpixel electrode 191b respectively include three and four unit pixel electrodes UP. The three unit pixel electrodes UP of the first subpixel electrode 191a are arranged vertically with their long sides oriented horizontally and facing each other. The four unit pixel electrodes UP of the second subpixel electrode 191b are formed below the first subpixel electrode 191a and arranged in two columns. The long sides of each column each other to form the second subpixel electrode 191b. The sizes of the unit pixel electrodes UP of the first subpixel electrode 191a and the second subpixel electrode 191b are different.

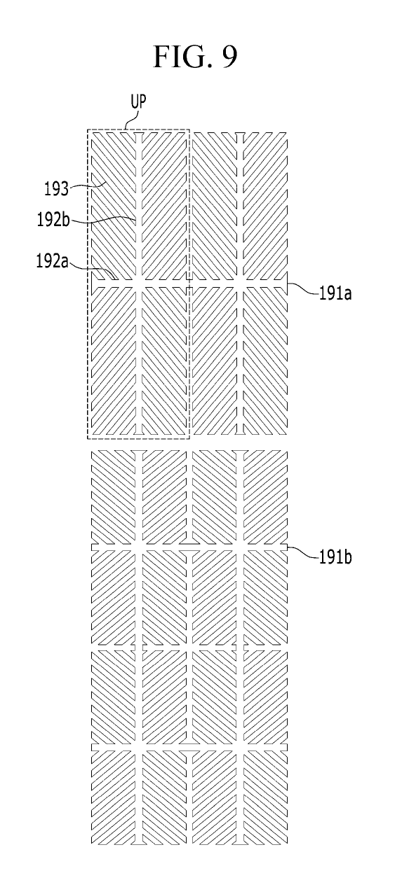

Referring to FIG. 9, the length of each of the short sides of the unit pixel electrode UP is equal to or less than about 100 μm, and the length of each of the long sides is equal to or greater than two times the short side. Each unit pixel electrode UP has a rectangular shape, and the first subpixel electrode 191a and the second subpixel electrode 191b respectively include two and four unit pixel electrodes UP. The two unit pixel electrodes UP of the first subpixel electrode 191a are positioned next to each other along one line, with their long sides oriented vertically and facing each other. Four unit pixel electrodes UP are formed under the first subpixel electrode 191a in two columns with their long sides oriented vertically and facing each other, to form the second subpixel electrode 191b. The sizes of the unit pixel electrodes UP of the first subpixel electrode 191a and the second subpixel electrode 191b are different.

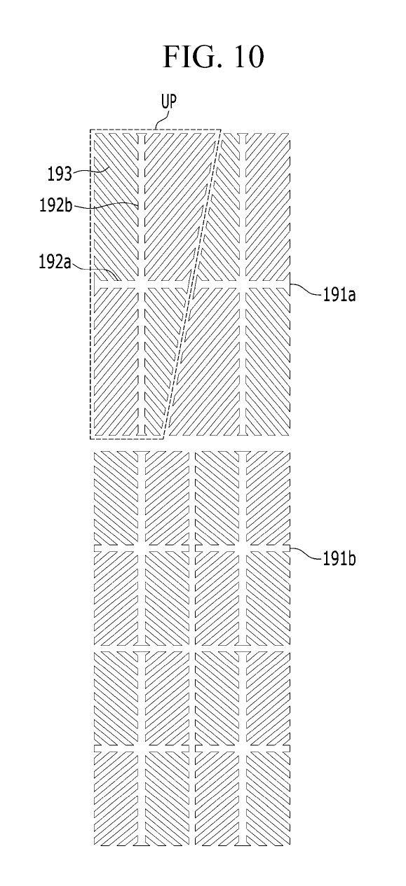

Referring to FIG. 10, the length of each of the short sides of each unit pixel electrode UP is equal to or less than about 100 μm, and the length of each of the long sides is equal to or greater than two times the short side. At least one of the unit pixel electrodes UP may have a trapezoidal shape, and the first subpixel electrode 191a and the second subpixel electrode 191b respectively include two and four unit pixel electrodes UP. The two unit pixel electrodes UP of the first subpixel electrode 191a each have a trapezoidal shape, and are formed with their long sides oriented at an angle and facing each other. Four unit pixel electrodes UP are formed under the first subpixel electrode 191a in two columns with their long sides oriented vertically and facing each other to form the second subpixel electrode 191b. The sizes and shapes of the unit pixel electrodes UP of the first subpixel electrode 191a and the second subpixel electrode 191b are different.

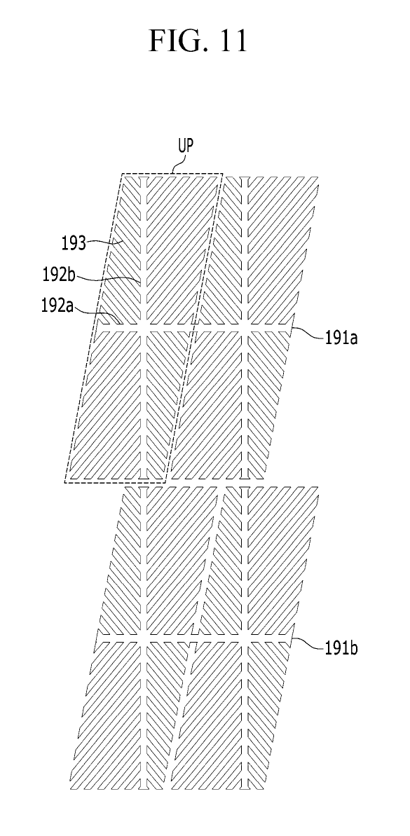

Referring to FIG. 11, the length of each of the short sides of the unit pixel electrodes UP is equal to or less than about 100 μm, and the length of each of the long sides is equal to or greater than two times the short side. Each unit pixel electrode UP may have a parallelogram shape, and the first subpixel electrode 191a and the second subpixel electrode 191b each include two unit pixel electrodes UP. The two unit pixel electrodes UP of the first subpixel electrode 191a are formed with their long sides oriented at angles and facing each other. Two unit pixel electrodes UP are formed below the first subpixel electrode 191a with their long sides oriented at angles and facing each other to form the second subpixel electrode 191b. The sizes and shapes of the unit pixel electrodes UP of the first subpixel electrode 191a and the second subpixel electrode 191b are the same.

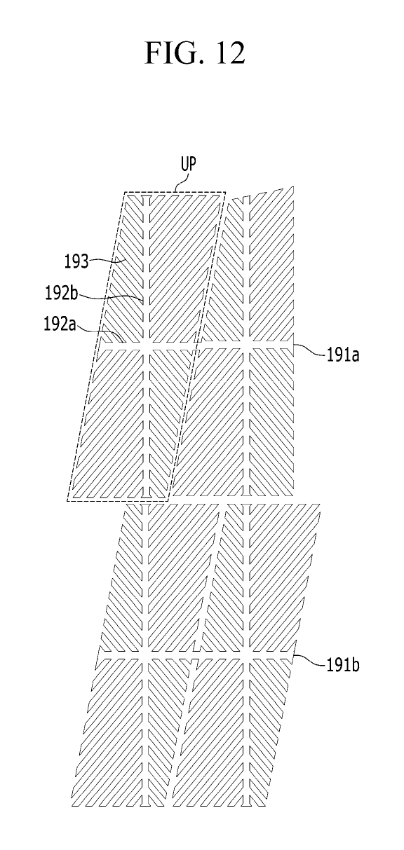

Referring to FIG. 12, the length of each of the short sides of the unit pixel electrodes UP is equal to or less than about 100 μm, and the length of each of the long sides is equal to or greater than two times the short side. At least one of the unit pixel electrodes UP may have a parallelogram shape, and the first subpixel electrode 191a and the second subpixel electrode 191b each include two unit pixel electrodes UP. The two unit pixel electrodes UP of the first subpixel electrode 191a are different in size and shape, and are formed adjacent to each other with longer sides that face each other. The sides of the unit pixel electrodes UP that face each other do not need to be parallel. Two unit pixel electrodes UP are formed under the first subpixel electrode 191a with their long sides oriented obliquely and facing each other to form the second subpixel electrode 191b. The unit pixel electrodes UP may be different in size and shape.

Although the pixel electrode 191 is oriented generally vertically in FIGS. 8 to 12, it may instead be oriented horizontally, as shown in FIG. 1 or 7.

While this disclosure has been described in connection with what is presently considered to be practical exemplary embodiments, it is to be understood that the disclosure is not limited to the disclosed embodiments. For example, if lengths of the short sides of the unit pixel electrode UP each are equal to or less than about 100 μm and lengths of the long sides are each equal to or greater than two times the lengths of the short sides, the unit pixel electrode UP may have various shapes other than rectangular, the numbers of the unit pixel electrodes UP of the first subpixel electrode 191a and the second subpixel electrode 191b may be different, and the sizes and shapes thereof may be different. That is, the unit pixel electrode UP may be implemented by various designs.

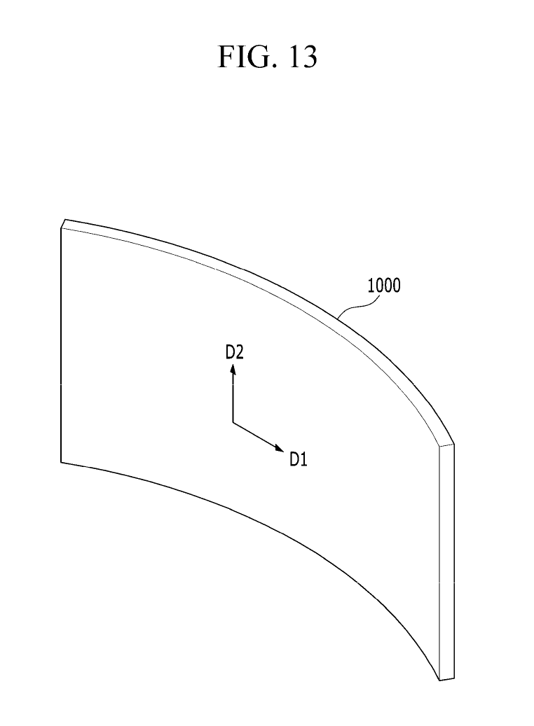

An exemplary embodiment in which an exemplary embodiment of the present disclosure is applied to a curved liquid crystal display will now be described with reference to FIG. 13.

FIG. 13 illustrates a perspective view of a liquid crystal display according to an exemplary embodiment of the present disclosure.

As shown in FIG. 13, a curved liquid crystal display 1000 according to an exemplary embodiment of the present disclosure is formed to be bent with a predetermined curvature. A first direction D1 is a direction in which the gate lines extend, and a second direction D2 is a direction in which the data lines extend. The curved liquid crystal display may be bent along a direction parallel to at least one of the first direction D1 and the second direction D2. That is, although the curved liquid crystal display 1000 is bent along the first direction D1 in FIG. 13, it may instead be bent in the second direction D2 or in both the first direction D1 and second direction D2 to varying degrees. The curved liquid crystal display 1000 according to the exemplary embodiment of the present disclosure is formed by manufacturing a flat liquid crystal display and then bending the same.

Regarding the flat liquid crystal display, the distance from the viewer's eye to a plurality of pixels included in the flat liquid display device varies. For example, the distance from the viewer's eye to pixels on the left and right edges of the flat display device may be longer than the distance from the viewer's eye to pixels at the center of the flat-panel display device. On the contrary, in the curved liquid crystal display 1000 according to the exemplary embodiment of the present disclosure, the distance from the viewer's eye to pixels of different positions is nearly constant, provided that the viewer's eye is at the center of curvature of the display. Since such a curved liquid crystal display provides a wider viewing angle than the flat-panel display device, photoreceptor cells are stimulated by more information, sending more visual information to the brain through optic nerves. Accordingly, the sense of reality and immersion may be heightened.

When the embodiments of the present disclosure are applied to a curved display device, since grooves, protrusions, or the like may be omitted in the common electrode and the process by which the liquid crystal molecules 31 are imparted a pretilt may be omitted, it is possible to prevent transmittance from deteriorating due to misalignment between the two display panels.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims. Various features of the above described and other embodiments can be mixed and matched in any manner, to produce further embodiments consistent with the invention.

### DESCRIPTION OF SYMBOLS

100: lower panel 121: gate line

124: gate electrode 154: semiconductor

171: data line 173: source electrode

175: drain electrode 185: contact hole

191a: first subpixel electrode 191b: second subpixel electrode

200: upper panel 270: common electrode

3: liquid crystal layer 31: liquid crystal molecule

What is claimed is:

1. A liquid crystal display comprising:
a first substrate;
a pixel electrode disposed on the first substrate and including one or more unit pixel electrodes;
a common electrode facing the pixel electrode; and
a liquid crystal layer disposed between the pixel electrode and the common electrode,
wherein a length of a short side of one unit pixel electrode is equal to or less than about 100 μm, a length of a long side of the one unit pixel electrode is equal to or greater than about two times the length of the short side, and
wherein the one unit pixel electrode includes a stem portion including a horizontal stem and a vertical stem crossing each other, and a plurality of minute branch electrodes extending from the stem portion.

2. The liquid crystal display of claim 1, wherein the one unit pixel electrode has a rectangular shape.

3. The liquid crystal display of claim 2, wherein the pixel electrode includes six unit pixel electrodes, and the six unit pixel electrodes are disposed sequentially along a line so that the long sides of adjacent unit pixel electrodes face each other.

4. The liquid crystal display of claim 3, wherein:
the liquid crystal layer includes a plurality of liquid crystal molecules, and
the liquid crystal molecules are aligned so that major axes thereof are substantially perpendicular to a surface of the first substrate when an electric field is not applied to the liquid crystal layer.

5. The liquid crystal display of claim 4, further comprising:
a gate line extending in a first direction and a data line extending in a second direction,
wherein the liquid crystal display is curved along a direction parallel to at least one of the first direction and the second direction.

6. The liquid crystal display of claim 5, wherein the common electrode is substantially planar.

7. The liquid crystal display of claim 2, wherein:
the pixel electrode includes a first subpixel electrode and a second subpixel electrode,
the first subpixel electrode and the second subpixel electrode each include two unit pixel electrodes, and
the two unit pixel electrodes are formed sequentially along a line so that short sides of the two unit pixel electrodes face each other.

8. The liquid crystal display of claim 7, wherein:
the liquid crystal layer includes a plurality of liquid crystal molecules, and
the liquid crystal molecules are aligned so that major axes thereof are substantially perpendicular to a surface of the first substrate when an electric field is not applied to the liquid crystal layer.

9. The liquid crystal display of claim 8, further comprising:
a gate line extending in a first direction and a data line extending in a second direction,
wherein the liquid crystal display is curved along a direction parallel to at least one of the first direction and the second direction.

10. The liquid crystal display of claim 2, wherein:
the pixel electrode includes a first subpixel electrode and a second subpixel electrode,
the first subpixel electrode includes three unit pixel electrodes that are formed sequentially along a line so that long sides of adjacent unit pixel electrodes face each other, and
the second subpixel electrode includes four unit pixel electrodes.

11. The liquid crystal display of claim 10, wherein:
the liquid crystal layer includes a plurality of liquid crystal molecules, and
the liquid crystal molecules are aligned so that major axes thereof are substantially perpendicular to a surface of the first substrate when an electric field is not applied to the liquid crystal layer.

12. The liquid crystal display of claim 11, further comprising:
a gate line extending in a first direction and a data line extending in a second direction,
wherein the liquid crystal display is curved along a direction parallel to at least one of the first direction and the second direction.

13. The liquid crystal display of claim 1, wherein:
the pixel electrode includes a first subpixel electrode and a second subpixel electrode,
the first subpixel electrode includes two unit pixel electrodes that are formed sequentially along a line so that long sides of the two unit pixel electrodes face each other, and
the second subpixel electrode includes four unit pixel electrodes.

14. The liquid crystal display of claim 13, wherein at least one of the unit pixel electrodes has a trapezoidal shape.

15. The liquid crystal display of claim 14, wherein:
the liquid crystal layer includes a plurality of liquid crystal molecules, and
the liquid crystal molecules are aligned so that long axes thereof are substantially perpendicular to a surface of the first substrate when an electric field is not applied to the liquid crystal layer.

16. The liquid crystal display of claim 15, further comprising:
a gate line extending in a first direction and a data line extending in a second direction,
wherein the liquid crystal display is curved along a direction parallel to at least one of the first direction and the second direction.

17. The liquid crystal display of claim 1, wherein:
the pixel electrode includes a first subpixel electrode and a second subpixel electrode,
the first subpixel electrode and the second subpixel electrode each include two unit pixel electrodes, and
at least one of the unit pixel electrodes has a parallelogram shape.

18. The liquid crystal display of claim 17, wherein the two unit pixel electrodes of the first subpixel electrode or the second subpixel electrode have different shapes.

19. The liquid crystal display of claim 18, wherein:
the liquid crystal layer includes a plurality of liquid crystal molecules, and
the liquid crystal molecules are aligned so that long axes thereof are substantially perpendicular to a surface of the first substrate when an electric field is not applied to the liquid crystal layer.

20. The liquid crystal display of claim 19, further comprising:
a gate line extending in a first direction and a data line extending in a second direction,
wherein the liquid crystal display is curved along a direction parallel to at least one of the first direction and the second direction.
